(19) United States
(12) Patent Application Publication
(10) Pub. No.: US 2007/0286171 A1
(43) Pub. Date: Dec. 13, 2007

(54) Multi-mode voice instant messaging internet phone (VIMIP) handset device

(76) Inventor: Huapeng Guan, Fremont, CA (US)

Correspondence Address: James Cai, Schein & Cai LLP, Suite 315, 100 Century Center, San Jose, CA, 95112, US

(21) Appl. No.: 11/438,456

(22) Filed: May 23, 2006

(51) Int. Cl. H04L 12/66

(52) U.S. Cl. 370/356

(57) ABSTRACT

A multi-mode Voice Instant Messaging Internet Phone (VIMIP) handset device that can effectuate a VoIP phone call to a standard phone or other IM client device (a personal computer with voice IM client software or another VIMIP handset device) with a telephone number associated therewith through an Instant Messaging system which supports VoIP phone call with a telephone number. The VIMIP handset device can also effectuate a VoIP conversation with other IM client device with voice capability using a buddy list through an Instant Messaging system with voice communication (voice chat) capability. In a first mode, the VIMIP handset device communicates in a wireless computer network connection mode and in second mode, in a wired computer network connection mode.

### FIELD OF THE INVENTION

The present invention provides of a multi-mode Voice Instant Messaging Internet Phone (VIMIP) handset device that functions as a Voice-over-Internet-Protocol (VoIP) phone to provide voice communications over a computer network, such as the Internet, through an Instant Messaging (IM) system.

### BACKGROUND

The Voice-over-Internet-Protocol (VoIP) is a protocol to route voice communications through an IP-based computer network to reduce cost of a telephone call. VoIP technology turns analog audio signals into digital data and transmits the digital data over the Internet or any other packet-switching data network using an Internet Protocol. This allows users to make phone calls via the Internet without going through a Public Switched Telephone Network (PSTN) system. With VoIP, the user is capable of making a phone call anywhere an Internet connection is available. With broadband connectivity, the call has better voice quality.

Traditional VoIP systems consist mainly of user interface devices, soft switches/Media Gateway Controller, and media gateways. The user interface devices for VoIP voice communications are available in a variety of types. The first type is a Personal Computer (PC) equipped with special software called “SoftPhone.” The SoftPhone software knows how to handle the VoIP call. To permit voice communications, the PC has sound cards, a microphone, a speaker and/or optionally, a headset with a microphone and speaker.

Another type of user interface devices for VoIP is a user voice-interface product based on the PC. This type of product includes soundcard-based handsets, universal serial bus (USB)-based handsets, and USB-based adapters for standard telephone sets or cordless telephone set. However, these user voice-interface products require a PC for Internet connectivity and work with various kinds of soft phones or specialized VoIP software running in the PC.

The third type of user interface devices for VoIP is an IP Phone. An IP Phone is a specialized VoIP phone set with a handset and a base with cradle and buttons. IP Phones connect directly to the Internet and have all the hardware and software necessary right onboard to handle the VoIP call. IP Phones look just like normal telephones, but without the standard RJ-11 phone connectors. Instead, IP Phones have RJ-45 Ethernet connectors, or have Wi-Fi WLAN connection capability.

The fourth type of user interface devices for VoIP is Standalone Analog Telephone Adaptors (SATA) that can connect to the Internet and have jackets to plug in standard telephone sets. The SATA has analog-to-digital/digital-to-analog converters which can convert the analog signal from a standard telephone into digital data for transmission over the Internet and convert the digital audio data from the Internet into analog signal for standard telephone. It allows a user to connect a standard telephone to an Internet connection for use with VoIP.

Traditional VoIP user interface devices need to connect to soft switches/Media Gateway Controller, and media gateways over the Internet infrastructure. A soft switch is a specialized database/mapping program running on a piece of hardware called call processor. Once connected, the user inputs a phone number into the VoIP user interface device. The VoIP user interface device sends the soft switch a request to connect to another VoIP device associated with the called telephone number. Since the user input is a phone number and the VoIP user interface device is identified using an IP address on the Internet, which may be dynamic, the soft switch needs to map the phone number to the target device's IP address in order to connect the calling VoIP user interface device to the called VoIP user interface device. If a soft switch does not have the information needed, the soft switch hands off the request downstream to other soft switches until one is found that can answer the request. Once a soft switch finds the called user, the soft switch locates the current IP address of the device associated with the requested telephone number. The soft switch sends back all the relevant information to the soft phone, IP phone or SATA device, allowing the exchange of data between the two VoIP user interface devices.

Soft switches work in tandem with the VoIP user interface devices on the network to make VoIP possible. In order for all of these devices to work together, they must communicate in the same way through a pre-defined protocol. Currently, there are three major protocols used for VoIP. One protocol is H.323, a standard created by the International Telecommunication Union (ITU). The second protocol is Media Gateway Control Protocol (MGCP) and the third protocol is Session Initialization Protocol (SIP). These protocols also include specifications for audio codecs. The audio codec specifies a method to convert an audio signal into a digital data and the corresponding method to convert the digital data back into an audio signal for replay. These three protocols are not always compatible. VoIP calls going between several networks may run into a snag if the VOIP call hits conflicting protocols.

The media gateways convert media provided in one type of network to the format required for another type of network. The media gateways are needed to connect the Internet to the Public Switched Telephone Network (PSTN) for dialing and communication between VoIP phone device and the standard telephone.

A VoIP system is typically setup by an Enterprise for use within the Enterprise. Some commercial VoIP systems have emerged, such VoIP system from Vonage and AT&T. These commercial VoIP systems allow consumers to use one of the available VoIP user interface device to place Internet phone calls. Also in the consumer VoIP market, Internet Telephone Service Providers (ITSP), such as Net2Phone, use systems based on edge gateway networks to offer PC-to-anywhere (PC-to-PC and PC-to-Phone) calling with special VoIP software on the PC.

Instant Messaging (IM) originally started with instant text messaging. The IM system normally consists of client applications in user computers and IM servers on the Internet. Once online, IM clients establish presence with at least one IM server and communicate with each other using IM protocols. There exist several public IM systems, such as AOL Instant Messenger, ICQ, Microsoft MSN (.Net) Messenger, Yahoo! Messenger, QQ, and Google Talk. Each of these IM systems has its own proprietary IM protocol to connect clients and servers and these protocols are un-compatible with each other. AOL Instant Messenger's protocol is OSCAR and TOC. ICQ's protocol is OSCAR. Yahoo! Messenger' protocol is YMSG. Microsoft MSN Messenger' protocol is Mobile Status Notification Protocol (MSNP). Google Talk's protocol is XMPP.

The way the IM system works for text messaging will now be described as using the example of ICQ. First, the user goes to the download page for ICQ and gets a copy of the free software (hereinafter referred to as “the client”) for the PC. Then the user installs the software and opens the client. The client tries to connect to the ICQ server using a proprietary protocol, such as ICQ v5, for communications. Once the client is connected to the ICQ server, the user can enter a name and password to log into the ICQ server. If this is the user's first time to log on, the user establishes an account and immediately begins using the IM service. When the ICQ server verifies the user's name and password, the user is logged in to the ICQ system. The client sends the ICQ server the connection information (IP address and number of the port assigned to the ICQ client) of the PC being used. The client also provides the user with the names of everyone in the ICQ contacts list (hereinafter referred to as “the buddy list”). The ICQ server creates a temporary file that has the connection information for the user and the list of the user's contacts. The client then checks to see if any of the users in the buddy list are currently logged in. If the ICQ server finds any of the user's in the buddy list logged in, the client sends a message back to the ICQ client on the PC with the connection information for each logged-in user in the buddy list. The ICQ server also sends the user's connection information to the people in the buddy list that are signed on. When the ICQ client gets the connection information for a person in the buddy list, the client changes the “status” of that person to “Online.” Thereafter, the user can click on the name of a person in your buddy list who is online, and a window opens that allows the user to enter text. After, the user enters a text message, the user clicks “Send” to communicate send the text message to the intended recipient.

Because the ICQ client has the IP address and port number for the computer of the intended recipient of the text message, the message is sent directly to the ICQ client on that person's computer. In other words, the ICQ server is not involved at this point. All communication is directly between the two clients. The other person gets the “instant message” and responds. The ICQ window that each user sees on each respective computer expands to include a scrolling dialog of the conversation. Each person's instant messages appear in this window on both computers. When the conversation is complete, the user closes the message window.

Eventually, the user goes offline and exits ICQ. When this happens, the ICQ client sends a message to the ICQ server to terminate the session. The ICQ server sends a message to the ICQ client of each person on your contact list that is currently online to indicate that you have logged off. Finally, the ICQ server deletes the temporary file that contained the connection information for the signing off ICQ client. In the ICQ clients of the buddy lists that are online, the signing off user name moves to the “Offline” status section.

While some of the details vary between different IM systems, the basic steps outlined above for ICQ system apply to all of the other public IM systems. One variation is that in, some IM servers may need to get involved to establish the connection between the two clients and when two client exchange messages, the communications may go through IM servers for some systems.

A voice Instant Messaging (IM) system, i.e. an Instant Messaging system with voice communication (voice chat) capability and/or support VoIP phone call with a telephone number, provides a new VoIP platform for consumer market. A voice Instant Messaging system offers free PC-to-PC voice communications traditionally. For PC-to-PC voice communications, the messages exchanged between clients are voice data, which are digitalized from the speaker's voice and converted back to analog voice for replay at the listener's speaker. With IM systems, such as Yahoo!, AOL, MSN and Google, starting to offer low-cost PC-To-Phone and Phone-To-PC calling services, it is becoming a communication platform of the future. For voice communication with IM, there exist a variety of PC-based user interface products.

The prior art approaches of providing client interface device for voice communication through voice IM systems are a variety of PC-based user interface products. There exist pure software-based user tools, which use the system soundcards with a microphone, a speaker or headset to interface with users for voice communications. A variation of this is the system soundcard-based handsets, which work with various software tools. USB-based handset or adapter for a standard telephone set provides a second soundcard instead of using the system soundcard in the PC to reduce echo. All these user interface products require a PC to work, which are quite inconvenient for voice communication.

As can be readily seen there is a continuing need for a convenient, standalone, cellular or mobile phone-like handset device for voice communication through a voice IM system without the need for a personal computer.

### SUMMARY OF THE INVENTION

The present invention provides of a new type of convenient, standalone, cellular phone-like handset device, which connects to a computer network, such as Internet, directly via wired (such as Ethernet) or wireless (such as Wi-Fi Wireless LAN) network connections; and functions as a client device for voice communications over the computer network, such as Internet, without user personal computers through an Instant Messaging (IM) system with voice communication (voice chat) capability and/or support VoIP phone call with a telephone number, such as AOL Instant Messenger, ICQ, Microsoft MSN (.Net) Messenger, Yahoo! Messenger, QQ, and Google Talk.

An object of the present invention is to provide a new type of convenient, standalone VoIP phone devices for voice communications over a computer network, such as Internet, through an IM system with voice communication (voice chat) capability and/or support VoIP phone call with a telephone number without user computers.

Another further object of the present invention is to provide a VIMIP handset device, which connects to a computer network, such as the Internet, directly via wired (such as Ethernet) or wireless (such as Wi-Fi Wireless LAN) network connections to effectuate a VoIP conversation/phone call over a voice IM system.

A still further object of the present invention is to provide a convenient, standalone handset device that can be turned on/off easily and instantly.

A still further object of the present invention is to provide a compact hand-held VIMIP handset device that is mobile and can go anywhere with the user. The VIMIP handset device can log-on to the widespread Wi-Fi WLAN networks when in the area of the WLAN network or plug into the Internet network directly at any available Internet access point.

A still further object of the present invention is to provide together with a voice IM system, a kind of standalone handset device that provides a complete Phone-To-Phone voice communication experience and solutions for consumers.

The above and other objects and features of the present invention will become apparent from the drawings, the description given herein, and the appended claims.

### BRIEF DESCRIPTION OF THE DRAWINGS

For a further understanding of the nature and objects of the present invention, reference should be had to the following description taken in conjunction with the accompanying drawings in which like parts are given like reference numerals and, wherein:

FIG. 1 illustrates a multi-mode VIMIP handset device in accordance with the present invention;

FIG. 2 illustrates a block diagram of a multi-mode VIMIP handset device;

FIG. 3 the program instruction for operating the multi-mode VIMIP handset device;

FIG. 4 illustrates a voice Instant Messaging (IM) system with VIMIP handset devices; and,

FIG. 5 illustrates a buddy list on the VIMIP handset display.

### DETAILED DESCRIPTION OF THE INVENTION

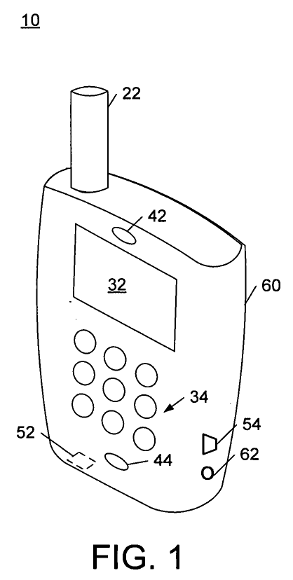

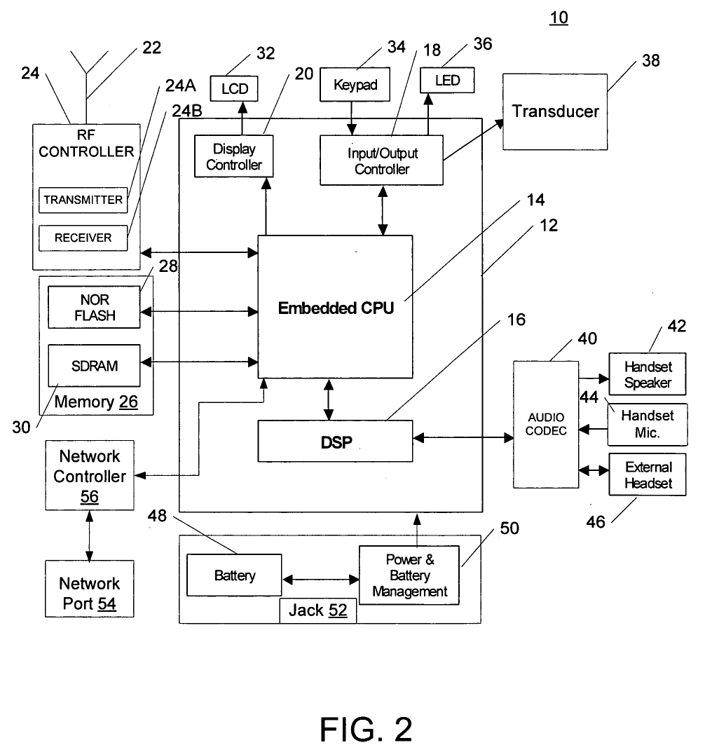

Referring now to the drawings, and in particular FIGS. 1-3, the multi-mode Voice Instant Messaging Internet Phone (VIMIP) handset device in accordance with the present invention will be referenced by the numeral 10. The multi-mode VIMIP handset device 10 functions in multiple modes depending on whether the network connection link is wireless or wired. For a wireless mode of operation, the multi-mode VIMIP handset device 10 is operable to communicate with the voice Instant Messaging server 120 through the Internet 115 via a wireless network connection, such as Wi-Fi Wireless LAN access point 130a, 130b. Alternately, in a wired mode of operation, the multi-mode VIMIP handset device 10 connects to the voice Instant Messaging server 120 through the Internet 115 via a wired network connection, such as Ethernet, to an Internet Access Equipment 125c, as will be described later.

The multi-mode VIMIP handset device 10 has a processing unit 12 housed in handset housing 60. The processing unit 12 includes an embedded central processing unit (CPU) 14 for general processing. The embedded CPU 14 can be an ARM processor, MIPS processor, PowerPC processor, or any other type of embedded processor. To improve audio performance, the processing unit 12 incorporates a DSP processor 16 to process audio codec, and handle echo cancellation, packet jitter and lost packet compensation.

The DSP processor 16 is electrically interfaced with a handset speaker 42, a handset microphone 44, and, optionally, an external headset 46 through an audio codec 40 which provides analog-to-digital conversion (ADC) and digital-to-analog conversion (DAC). The external headset 46 is adapted to be coupled to the handset housing 60 via port 62 coupled in the side of the handset housing 60. Nevertheless, the DSP processor 16 is also capable of communicating and interfacing with Bluetooth enabled devices and headsets.

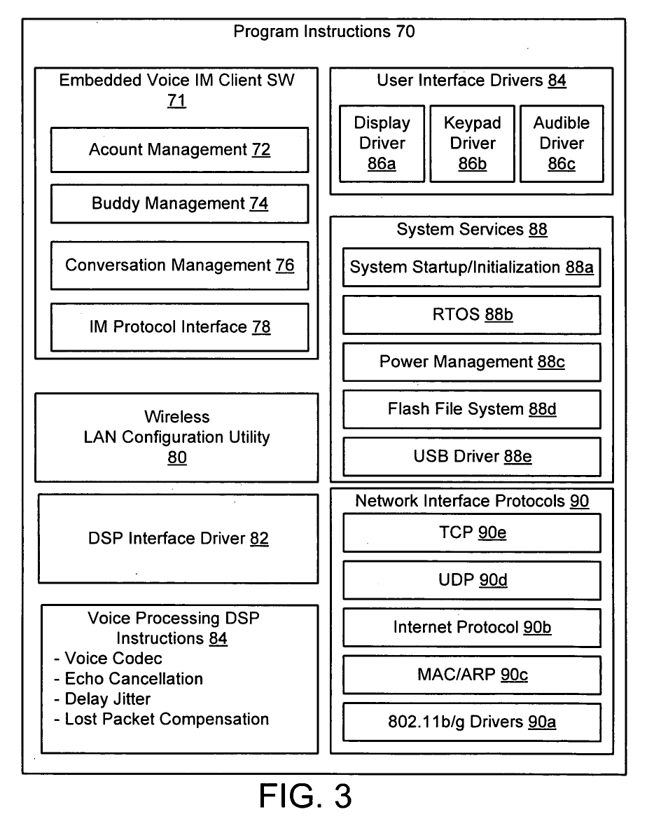

The embedded CPU 14 uses memory 26 to store executable program instructions 70 (FIG. 3) and other data. NOR Flash memory 28 is used to store the program instructions 70 and other data at power-off time. On the other hand, memory 26 also includes random access memory, such as SDRAM 30, which is used at run-time to store the program instructions 70 and other data. The embedded CPU 14 interfaces with a liquid crystal display (LCD) 32 through a display controller 20. The embedded CPU 14 also interfaces with the handset keypad 34, a light emitting diode (LED) and transducer 38 for ring tones through an input/output controller 18. The housing 60 of device 10 is preferable a cellular-telephone handset style. For example, the top of the housing has an antenna and a speaker. At the bottom of housing 60, the handset microphone 44 is provided for picking up the user's voice when the speaker 42 is placed in proximity to the user's ear and the microphone 44 is placed in proximity to the user's mouth.

In the exemplary embodiment, the handset housing 60 houses therein battery 48 for powering the electrical components of the multi-mode VIMIP handset device 10. The battery 48 is coupled to a power and battery management unit 50. The power and battery management unit 50 delivers the necessary power to each individual component according to various programmed sequences. For example, after a predetermined time interval of inactivity, some or all of the electrical components may be powered down to a sleep mode. Furthermore, power is shut off when a turn off command from a key on the keypad 34 is received. The battery 48 is capable of being recharged through jack 52 (shown in phantom). The jack 52 is adapted to be coupled to a power cord (not shown) for delivering utility power to the battery 48 for recharging.

To permit wireless communications in the wireless mode of operation, the handset housing 60 has a radio frequency (RF) antenna 22 coupled externally thereto. The RF antenna 22 is electrically coupled to the embedded CPU 14 via an RF controller 24 which includes a RF transmitter 24A and receiver 24B.

To permit wired communications in the wired mode of operation, the handset housing 60 has at least one network port 54 such as without limitation a USB port or RJ-45 Ethernet connection. A network port 54 is electrically coupled to the embedded CPU 14 via a network controller 56. The network controller 56, such as Ethernet controller or USB controller, handles wired connection to an Internet Access Equipment 125C.

The executable program instructions 70 for the operation of the multi-mode VIMIP handset device 10 will now be described in relation to FIG. 3. The executable program instructions 70 include an embedded Voice IM Client Software (SW) 71 that is a software module. The embedded Voice IM Client SW 71 has four major sub-modules—account management sub-module 72, buddy management sub-module 74, conversation management sub-module 76, and IM protocol interface sub-module 78. The account management sub-module 72 handles user IM account creation and setup. The buddy management sub-module handles the users' buddy list or contact list. The conversation management sub-module 76 handles the invitation/dialing, response, and termination of user voice conversations. The IM protocol interface 78 handles the different IM protocols of various IM systems (selects the appropriate protocol), such as AOL Instant Messenger, ICQ, Microsoft MSN (.Net) Messenger, Yahoo! Messenger, QQ, and Google Talk, to communicate with each IM system's server 120. The VIMIP handset device 10 is applicable to all voice IM systems, whether public or private and/or whether full (buddy and telephone number lists) or partial (buddy list) voice communications are supported. The IM protocol interface 78 supports different IM protocols, different server mechanisms such as centralized server or distributed Peer-to-Peer server.

The conversation management sub-module 76 may also interface with voice processing DSP instruction module 84 through a DSP interface driver 82 to process the voice media signal. The voice processing DSP instruction module 84 has the capabilities of voice encoding/decoding, echo cancellation, delay handling, jitter handling and lost packet compensation. The voice processing DSP instruction module 84 controls the handset microphone 44, handset speaker 42, and, optionally, external headset 46 through the audio codec 40. The functionality of the voice processing DSP instruction module 84 can also be implemented through non-DSP instructions which would interface with audible driver 86c to control the handset microphone 44, handset speaker 42, and, optionally, external headset 46 through the audio codec 40. The conversation management sub-module 76 also interfaces with the network interface protocols 90, which include the 802.11b/g drivers 90a for Wireless LAN access via wireless access points 130a and 130b, to send/receive the voice data packets through the Internet 115. The embedded voice IM Client SW 71 uses display driver 86a for displaying graphical user interfaces and receives user keypad input through keypad driver 86b.

The program instructions 71 further include network interface protocols 90 for communicating over the Internet 115 that include Internet Protocol (IP) 90b, User Datagram Protocol (UDP) 90d and Transmission Control Protocol (TCP) 90e which runs on top of the IP 90b. The UDP 90d provides a connectionless protocol while the TCP 90e provides a connection-oriented protocol. The network interface protocols 90 further include a medium access control layer and an address resolution protocol (MAC/ARP) 90c. The medium access control layer has different modules to handle wired network connection methods, such as Ethernet, and wireless network connection methods, such as WiFi WLAN. For wired connection with an USB-type network port 54, the USB Drivers 88e are needed.

For the wireless mode of operation, the executable program instructions 70 of the multi-mode VIMIP handset device 10 include a Wireless LAN (WLAN) configuration utility module 80, which interfaces with 802.11b/g Drivers 90a, to set up the WLAN configuration parameters, such as, without limitation, Wireless Network Name (Service Set Identifier—SSID), access mode, channel number, keys if security encryption is enabled.

These above-mentioned software modules within executable program instructions 70, except for DSP instructions, may run on top of an embedded real time operating system (RTOS), such as embedded Linux or Windows CE. The program instructions 70 include a system services module 88 having four sub-modules—a system startup/initialization sub-module 88a, real time operating system (RTOS) sub-module 88b, power management sub-module 88c and a flash file system sub-module 88d. The flash file system sub-module 88d is needed to use the NOR FLASH memory 28. Also a system startup/initialization sub-module 88a handles the system power up and loads the RTOS 88b. The power management sub-module 88c controls the power and battery management unit 50.

### Modes of Communication

A user of an Instant Messaging system with voice communication (voice chat) capability, such as AOL Instant Messenger, ICQ, Microsoft MSN (.Net) Messenger, Yahoo! Messenger, QQ, and Google Talk, can use the VIMIP handset device 10a, 10b, 10c to choose his buddy from his buddy list and invite his buddy to talk. The user can also use the VIMIP handset device 10a, 10b, 10c to dial a telephone number to start a phone call if the IM system supports VoIP phone call with a telephone number. The VIMIP handset device is able to alert its owner whenever there is invitation of voice communication for him. The following description assumes that the IM systems involved are voice IM systems which have voice communication capability and support VoIP phone call with a telephone number.

To use the multi-mode VIMIP handset device 10, a user needs to create an account with the operator of an IM system server 120 and chooses a user account name and password. In order to allow a PSTN telephone call via PSTN 118 through the multi-mode VIMIP handset device 10, the user needs to obtain (such as by purchasing) a telephone number from the operator of the IM system server 120 and have the telephone number linked to the IM system account in the IM system 100. This registration process can be done through the multi-mode VIMIP handset device 10, a PC client software, or by calling the operator of the IM system server 120. If the registration process is not done with the multi-mode VIMIP handset device 10, the user needs to set his account name and password to the multi-mode VIMIP handset device 10, maybe together with the telephone number for the multi-mode VIMIP handset device 10.

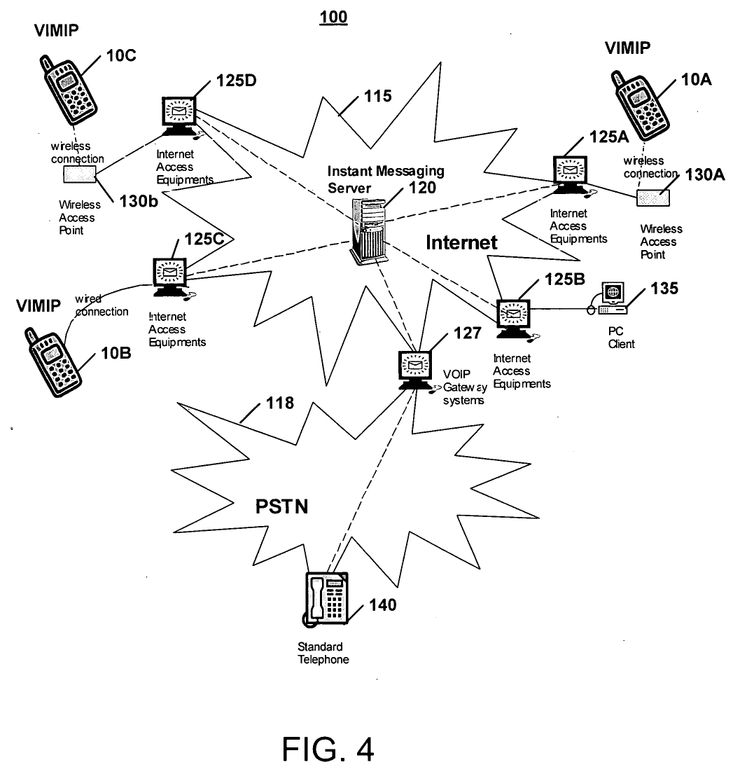

Referring now to FIG. 4, after the registration process, when the multi-mode VIMIP handset device 10a is powered up, the multi-mode VIMIP handset device 10a searches for an available wireless network connection in the first mode of operation such as by finding a nearby wireless access point 130a or 130b of a Wi-Fi WLAN. After the multi-mode VIMIP handset device 10 finds a wireless network connection, the device 10a tries to connect to the IM system server 120. Once the device 10a connects to the IM server 120, the device 10 logins into the server 120 with the user account name and password, establishes presence status with the server 120. Thereafter, the device 10a receives the presence status and connection information of the user's buddies on his buddy list. This login process is the same as normal software clients connecting to IM systems, as described previously.

Alternately, if the VIMIP handset device 10b is connected to the Internet Access Equipment 125c via a wired connection, the operations of device 10b switch to the wired mode of communications, the second mode, to connect to IM server 120.

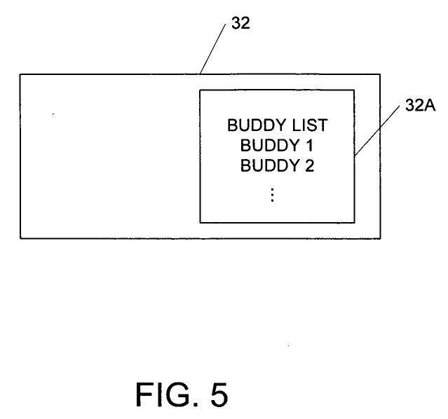

The process for effectuating a VoIP phone call or voice communication from the device 10a to another device 10b, 10c or PC Client 135 with voice IM client software using a buddy list will now be described. First, a user selects the name of a person in his buddy list in the buddy list display field 32a (FIG. 5) who is online, and invites a selected buddy to talk. Second, the device 10a sends a request of invitation for a voice talk to that the respective buddy device 10b, 10c or the software client on PC 135, since the user's device 10a has the IP address and port number of that device 10b, 10c or PC 135 through the login process with the IM server 120. Third, the buddy receives the user's invitation and selects to accept the invitation to talk wherein an “Accept” response is sent from a buddy device 10b, 10c or the software client on PC 135 to the user's device 10a. Fourth, the user may start to talk to his buddy now after the device indicates to him that the connection is on. The voice data is sent directly from the user' device 10a to the buddy device 10b, 10c or the software client on that PC 135. The buddy hears the user's voice and may respond. When the voice communication is complete, either party can quit the conversation by turning off the talk function of the VIMIP handset device 10a, 10b, 10c or PC 135 and the status is sent to the other party's device. Although a buddy list is shown in the buddy list display field 32a (FIG. 5), the buddy list may be a list of telephone numbers or buddy telephone numbers of other IM-enabled devices with telephone numbers assigned thereto from the IM system 100. The process for a VoIP phone call by selecting a telephone number in the buddy list will be described later.

The steps outlined above are a general description for voice communication through IM system 100 using a buddy list. Some variations may exist for a particular IM system 100. One variation is that some IM servers 120 may need to get involved to establish the connection between the two devices 10a, 10b or PC 135 and the voice data needs to go through the IM server 120 for exchange between the user' device 10a and that his buddy's VIMIP handset device 10b, 10c or the software client on PC 135. The steps involved for a PC 135 with software client to talk to a VIMIP device using its buddy list are similar to the steps outlined above.

To establish a VoIP phone call from the VIMIP device 10a by dialing a telephone number of standard PSTN telephone 140 will now be described. To dial a telephone 140 coupled to the PSTN 118, the user of the device 10a dials the telephone number using the keypad 34 or the user can select the telephone number in the buddy list. Thereafter, the VIMIP device 10a sends the request of connecting with telephone number to the IM server 120. The IM server 120 realizes the telephone number is for a standard PSTN telephone 140 and finds the IP address and port number of the appropriate Media Gateway 127 for the telephone number through the internal network of the IM system server 120. The IM server 120 sends the user's request to the Media Gateway 127, which tries to connect to the standard telephone 140 with the requested telephone number, and IM server 120 establishes the connection between the user's device 10a and the Media Gateway 127, either by sending their IP addresses and port numbers to each other so that they have a direct connection with each other, or by acting as connection point between them. The standard telephone's user picks up the phone (off hook), and the status is sent to the user's device 10a from the Media Gateway 127. The user and the standard telephone's user can start to talk like a normal phone call. The voice data from the user's device 10a is sent through the connection path, either directly to the Media Gateway 127 or through the IM server 120 to reach the Media Gateway 127. The Media Gateway 127 converts the voice data to audio signals that are sent to the standard telephone 140 through PSTN 118. The audio signal from the standard telephone 140 goes through a reversed path to reach the user's device 10a.

When the phone call is complete, either party can quit the conversation by turning off the talk function of the device 10a or hanging up the standard telephone 140, and the status is sent to the other party's device 10a or the standard telephone 140.

The process outlined above is an exemplary description for voice communication through IM system 100 between a VIMIP handset device 10a and a standard telephone 140 that effectuates a VoIP phone call. Some variations may exist for a particular IM system. The steps involved for a standard telephone 140 to dial a number assigned to a VIMIP handset device 10a (through the device owner's IM account) are the reverse description of the steps outlined above.

The process for a VoIP phone call from the VIMIP handset device 10a by dialing a telephone number assigned to an IM account will now be described in detail. The user dials the telephone number via keypad 34 of the multi-mode VIMIP handset device 10a or the user can select the telephone number in the buddy list. The VIMIP handset device 10a sends the request of connecting with telephone number to the IM server 120. The IM server 120 realizes the telephone number is assigned to an IM account and finds the IP address and port number of the VIMIP device 10b, 10c or client PC 135 associated with that telephone number if the owner of the account is online. The IM server 120 sends the user's request to the VIMIP handset device 10b, 10c or PC 135 associated with that telephone number, and the IM server 120 establishes the connection between the user's VIMIP handset device 10a and to the VIMIP handset device 10b, 10c or PC 135 associated with that telephone number, either by sending their IP addresses and port numbers to each other so that they have a direct connection with each other, or by acting as connection point between them.

The user of devices 10b, 10c or PC 135 with the telephone number picks up the VoIP phone call, and the status is sent to the user's VIMIP device 10a from the VIMIP handset device 10b, 10c or PC 135. The user and the telephone number's owner can start to talk like a normal phone call. The voice data are exchanged directly between the user's VIMIP devices 10a and the VIMIP device 10b, 10c or client PC 135 associated with that telephone number, or through the IM servers to reach each other. When the phone call is complete, either party can quit the conversation by turning off the talk function of the VIMIP handset device 10a, 10b, 10c or PC 135 and the status is sent to the other party's device.

The steps outlined above are a general description for voice communication through IM system 100 by dialing a telephone number assigned to an IM account through a VIMIP device. Some variations may exist for a particular IM system. The steps involved for a client computer with software client to dial a number assigned to a VIMIP handset device 10a (through the device owner's IM account) are similar to the steps outlined above.

When the VIMIP handset device 10a, 10b, 10c is powered off, it tries to send a message to the IM server 120 to terminate the login session. The IM server 120 sends a message to the IM client of each person in the logging off user's buddy list that is currently online to indicate that the device 10a has logged off.

As shown in the system diagram of FIG. 4, the VIMIP handset device 10a is a cellular phone-like handset (FIG. 1) which functions in either a wired mode and/or a wireless mode via wired/wireless network connections. For wireless network connection, VIMIP handset device 10a, 10c can be connected to a Wi-Fi Access Point 130a, 130b through Institute of Electrical and Electronics Engineers (IEEE) standard 802.11a, IEEE standard 802.11b, IEEE standard 802.11g, and/or any other WLAN technologies. The Wi-Fi Wireless Access Point is linked to the Internet Access Equipment 125a, 125d through an Ethernet cable or any other LAN technologies. The Internet Access Equipment 125a, 125b, 125c, 125d can be a broadband modem, such as Cable Modem or DSL model, or a switch/router connected to a broadband modem, or a switch/router connected to a high-speed Internet connect connection, such as a T-1 line. The Wi-Fi Wireless Access Point 130a, 130b can also be part of the Internet Access Equipment 125a, 125d, such as a wireless router with built-in Wi-Fi Wireless Access Point. For wired network connection, VIMIP handset device can be connected to the Internet Access Equipment through Ethernet cable directly. VIMIP handset device 10b can be connected to Internet Access Equipment 125c through Ethernet cable, while PC 135 can also be connected to Internet Access Equipment 125b through Ethernet cable. The Internet Access Equipment 125a, 125b, 125c, 125d connect VIMIP handset device 10a, 10b, 10c and PC 135 to IM system server 120 through the Internet 115.

The Internet Access Equipments 125a, 125b, 125c and 125d are not limited to the items mentioned above. Also the network connection methods are not limited to methods mentioned above. The wireless network connections effectuated through wireless 2.5G, wireless 3G and future cellular wireless technologies by a mobile cellular phone may also be considered as ways to connect the VIMIP handset device 10a, 10b to IM server 120. Also a data modem through telephone line is another example wired network connection for device 10b. For wireless network connection, WiMAX and other Wide-Area Wireless Networking technologies in development now should be considered as ways to connect VIMIP handset device 10a, 10b to IM server 120.

The VIMIP handset device 10a, 10b and 10c are operable to communicate (send and receive) text messages via the IM system 100. Since text messaging is well known and is the basic service of an IM system 100, no further description is provided.

In view of the numerous modifications which could be made to the preferred embodiments disclosed herein without departing from the scope or spirit of the present invention, the details herein are to be interpreted as illustrative and not in a limiting sense.

I claim:

1. A multi-mode Voice Instant Messaging Internet Phone (VIMIP) handset device comprising:
a handset housing having a built-in speaker, microphone, a keypad, antenna for receiving and transmitting radio frequency signals and an computer network access connection for wired communications; and,
processing unit housed in the handset housing and having program instructions which upon execution are operable to effectuate a Voice-over-Internet-Protocol (VoIP) phone call to another voice communications device to provide voice communications through a voice Instant Messaging (IM) system having voice communications capability via the antenna in a first mode of operation or via the wired computer network access connection in a second mode of operation.

2. The device according to claim 1, wherein the another voice communication device includes at least one of a personal computer with voice IM client software, another VIMIP handset device, or a standard telephone coupled to a public switch telephone network.

3. The device according to claim 1, wherein the handset connects to the voice IM system in the first mode via Wi-Fi Wireless local area network connections.

4. The device according to claim 1, wherein the handset connects to the voice IM system in the second mode via an Ethernet connection.

5. The device according to claim 1, wherein the handset connects to the voice IM system in the second mode via a USB connection.

6. The device according to claim 1, wherein the handset communicates voice communications without a user's personal computer through the voice IM system.

7. The device according to claim 1, further comprising:
a display integrated in the handset housing which can display a buddy list with at least one buddy entry;
voice communication management module operable to start the VoIP phone call with another voice IM-enabled client device through the voice IM system upon selection of the at least one buddy entry on the display.

8. The device according to claim 7, further comprising:
a display integrated in the handset housing which can display a telephone number for placing a VoIP phone call to another voice communications device through the IM system.

9. The device according to claim 1, wherein the program instructions, upon execution, further function to process a voice signal of the VoIP phone call using at least one of voice codecs with the capabilities to handle echo cancellation, delay, jitter, and lost packet compensation.

10. The device according to claim 1, wherein the program instructions, upon execution, further provide a plurality of network interface protocols including Transmission Control Protocol (TCP), User Datagram Protocol (UDP), Internet Protocol (IP), a medium access control layer and an address resolution protocol (MAC/ARP), and Institute of Electrical and Electronic Engineers (IEEE) standard 802.11 drivers.

11. The device according to claim 1, wherein the program instructions, upon execution, further provide a wireless local area network (WLAN) configuration utility for connecting to Wi-Fi WLAN networks.

12. The device according to claim 1, wherein the program instructions, upon execution, further provide account management, buddy list management and conversation management.

13. The device according to claim 1, wherein the handset device has assigned thereto a telephone number associated with a user account of the voice IM system.

14. The device according to claim 1, wherein the program instructions, upon execution, provide an IM protocol interface operable to select one IM protocol of a plurality of IM protocols for communicating with the IM system.

15. The device according to claim 14, wherein the plurality of IM protocols include AOL Instant Messenger, ICQ, Microsoft MSN (.Net) Messenger, Yahoo! Messenger, QQ, and Google Talk.

16. A multi-mode Voice Instant Messaging Internet Phone (VIMIP) handset device comprising:
means for housing and integrating together in a handheld structure a built-in speaker, microphone, a keypad, antenna for receiving and transmitting radio frequency signals and a computer network access connection for wired communications; and,
means, housed in the housing means, for processing a voice call to effectuate a Voice-over-Internet-Protocol (VoIP) phone call to another voice communication device to provide voice communications through a voice Instant Messaging (IM) system having voice communications capability via the antenna in a first mode of operation or via the wired computer network access connection in a second mode of operation.

17. The device according to claim 16, wherein the another voice communication device includes at least one of a personal computer with voice IM client software, another VIMIP handset device, or a standard telephone coupled to a public switch telephone network.

18. The device according to claim 16, wherein the processing means connects to the voice IM system in the first mode via Wi-Fi Wireless local area network connections.

19. The device according to claim 16, wherein the processing means connects to the voice IM system in the second mode via an Ethernet connection.

20. The device according to claim 16, wherein the device communicates voice communications without a user's personal computer through the voice IM system.

21. The device according to claim 16, further comprising:
means for displaying, integrated in the housing means, a buddy list with at least one buddy entry;
means for managing the voice communications and for starting the VoIP phone call with another voice IM-enabled client device through the IM system upon selection of the at least one buddy entry on the displaying means.

22. The device according to claim 16, further comprising:
means for displaying, integrated in the housing means, a telephone number for placing the VoIP phone call to another voice communications device through the IM system.

23. The device according to claim 16, wherein the processing means comprises means for processing a voice signal of the VoIP phone call using at least one of voice codec with the capabilities to handle echo cancellation, delay, jitter, and lost packet compensation.

24. The device according to claim 16, wherein the processing means comprises means for providing a plurality of network interface protocols including Transmission Control Protocol (TCP), User Datagram Protocol (UDP), Internet Protocol (IP), a medium access control layer and an address resolution protocol (MAC/ARP), and Institute of Electrical and Electronic Engineers (IEEE) standard 802.11 drivers.

25. The device according to claim 16, wherein the processing means comprises means for providing a wireless local area network (WLAN) configuration utility for connecting to Wi-Fi WLAN networks.

26. The device according to claim 16, wherein the processing means comprises means for providing account management, buddy list management and conversation management.

27. The device according to claim 16, wherein the handset device has assigned thereto a telephone number associated with a user account of the voice IM system.

28. The device according to claim 16, further comprising:
means for selecting one IM protocol of a plurality of IM protocols for communicating with the IM system.

29. The device according to claim 28, wherein the plurality of IM protocols include AOL Instant Messenger, ICQ, Microsoft MSN (.Net) Messenger, Yahoo! Messenger, QQ, and Google Talk.

30. A method for Voice-over-Internet-Protocol (VoIP) voice communications via a voice Instant Messaging (IM) system with voice communications capability comprising the steps of:
processing a voice call via a Voice Instant Messaging Internet Phone (VIMIP) handset device to effectuate a Voice-over-Internet-Protocol (VoIP) phone call to another voice communication device to provide voice communications through the voice IM system via radio frequency communication link in a first mode of operation; and,
processing the voice call via the VIMIP handset device to effectuate the Voice-over-Internet-Protocol (VoIP) phone call to the another voice communication device to provide voice communications through the voice IM system via a wired computer network access connection in a second mode of operation when the radio frequency communication link is not available.

31. The method according to claim 30, wherein the another voice communication device includes at least one of a personal computer with voice IM client software, another VIMIP handset device, or a standard telephone coupled to a public switch telephone network.

32. The method according to claim 30, wherein the processing step includes the step of: connecting to the voice IM system in the first mode via Wi-Fi Wireless local area network connections.

33. The method according to claim 30, wherein the processing step includes the step of:
connecting to the voice IM system in the second mode via an Ethernet connection.

34. The method according to claim 30, further comprising the steps of:
displaying on the handset device a buddy list with at least one buddy entry;
managing the voice communications and for starting the VoIP phone call with another voice IM-enabled client device through the IM system upon selection of the at least one buddy entry.

35. The method according to claim 30, further comprising the steps of:
displaying on the handset device a telephone number for placing the VoIP phone call to another voice communications device through the IM system.

36. The method according to claim 30, further comprising the step of:
selecting by an IM protocol interface a respective one IM protocol of a plurality of IM protocols for communicating with the IM system.

37. The device according to claim 36, wherein the plurality of IM protocols include AOL Instant Messenger, ICQ, Microsoft MSN (.Net) Messenger, Yahoo! Messenger, QQ, and Google Talk.
